(19) United States
(12) Patent Application Publication
(10) Pub. No.: US 2008/0261667 A1
(43) Pub. Date: Oct. 23, 2008

(54) MOBILE TERMINAL HAVING AN IMPROVED INTERNAL ANTENNA

(75) Inventors: Dong Ho Lee, Seoul (KR); An-Sun Hyun, Seoul (KR); SungShin Kong, Seoul (KR)

Correspondence Address: LEE, HONG, DEGERMAN, KANG & SCHMADEKA, 660 S. FIGUEROA STREET, Suite 2300, LOS ANGELES, CA, 90017, US

(73) Assignee: LG ELECTRONICS INC.

(21) Appl. No.: 12/104,821

(22) Filed: Apr. 17, 2008

(30) Foreign Application Priority Data
Apr. 19, 2007 (KR) 10-2007-0038406

(51) Int. Cl. H04M 1/03

(52) U.S. Cl. 455/575.7

(57) ABSTRACT

A mobile terminal is provided that includes a first area having a first conductive surface, a second area having a second conductive surface, the second area separated from the first area, and a feeding point formed between the first conductive surface and the second conductive surface to supply electrical signals to or from the first and the second conductive surfaces. The first and the second conductive surfaces together from an internal antenna

This application claims priority under 35 U.S.C. §119(a) on Patent Application No. 10-2007-0038406 filed in Republic of Korea on Apr. 19, 2007, the entire contents of which are hereby incorporated by reference.

### BACKGROUND OF THE INVENTION

1. Field of the Invention

This invention generally relates to mobile electronic apparatuses and more particularly to mobile communication terminals having an internal antenna.

2. Discussion of the Related Art

A mobile terminal that uses an antenna is one of a number of mobile electronic apparatuses that provide for the wireless transmission and reception of information, as well as for the inspection or processing of information, while the user is moving.

As mobile terminals decrease in thickness and weight making them more convenient for a user to carry, the various elements needed to provide various functions are required to be placed within a small and limited space and required to provide high wireless communication performance.

Mobile terminals first used external antennas exposed to the outside of the mobile terminal for wireless communication. However, an external antenna has an adverse effect on the appearance of a mobile terminal and can be easily damaged by external impact. Consequently, internal antennas mounted on the inside of a mobile terminal have been developed.

However, an area of 2 to 4 cc is generally required to secure the performance of an internal antenna in a mobile terminal. This is because sufficient height is required to secure a predetermined bandwidth of a corresponding band. As a result, mounting an antenna within the mobile terminal mobile terminals does not facilitate decreased size and thickness.

Further, an antenna's performance is greatly influenced by a human body. A human body can cause the Total Radiated Power (TRP) and Total Isotropic sensitivity (TIS) of an internal antenna to decrease by 7 dB or more.

### SUMMARY OF THE INVENTION

An aspect of the invention is to provide a mobile terminal that can minimize the space needed for mounting an antenna on the inside of the mobile terminal and have good antenna performance, where the mobile terminal has a first area having a first conductive surface, a second area having a second conductive surface, the second area separated from the first area, and a feeding point formed between the first conductive surface and the second conductive surface to supply electrical signals to or from the first and the second conductive surfaces, such that the first and the second conductive surfaces together form an internal antenna.

Another aspect of this invention is to provide a mobile terminal that does not require the mounting of a separate antenna, by using the ground of a printed circuit board disposed in the mobile terminal, a bracket of a display of the mobile terminal, or a conductive paint layer coated on the housing of the mobile terminal for the first and second conductive surfaces.

### BRIEF DESCRIPTION OF THE DRAWINGS

The details of one or more embodiments are set forth in the accompanying drawings and the description below. In the entire description of this invention, like reference numerals represent corresponding parts throughout the various drawings.

FIG. 1 is a block diagram illustrating the configuration of a mobile terminal;

FIG. 2 is a plan view of an embodiment of a mobile terminal in accordance with the invention having a signal connection line and a separation area, in which the signal connection line does not pass through the separation area;

FIG. 3 is a side view of the mobile terminal of FIG. 2;

FIGS. 4 to 6 show portions of a mobile terminal in accordance with the invention and illustrate alternative embodiments of a second conductive surface;

FIG. 7 is an equivalent circuit diagram of an embodiment of a mobile terminal in accordance with the invention in which a signal connection line does not pass through a separation area, in which a power connection point is formed in the separation area, and in which an inductor and a capacitor are connected to the power connection point;

FIG. 8 is a plan view of an alternative embodiment of a mobile terminal in accordance with the invention in which a signal connection line passes through a separation area;

FIG. 9 is an equivalent circuit diagram of the embodiment of the mobile terminal shown in FIG. 8 in which a power connection point is formed in the separation area and in which an inductor and a capacitor are connected to the power connection point; and

FIG. 10 is a plan view of an embodiment of a mobile terminal in accordance with the invention in which the feeding point is formed in the first printed circuit board.

### DETAILED DESCRIPTION OF THE PREFERRED EMBODIMENTS

Hereinafter, embodiments of the mobile terminal will be described in detail with reference to the accompanying drawings.

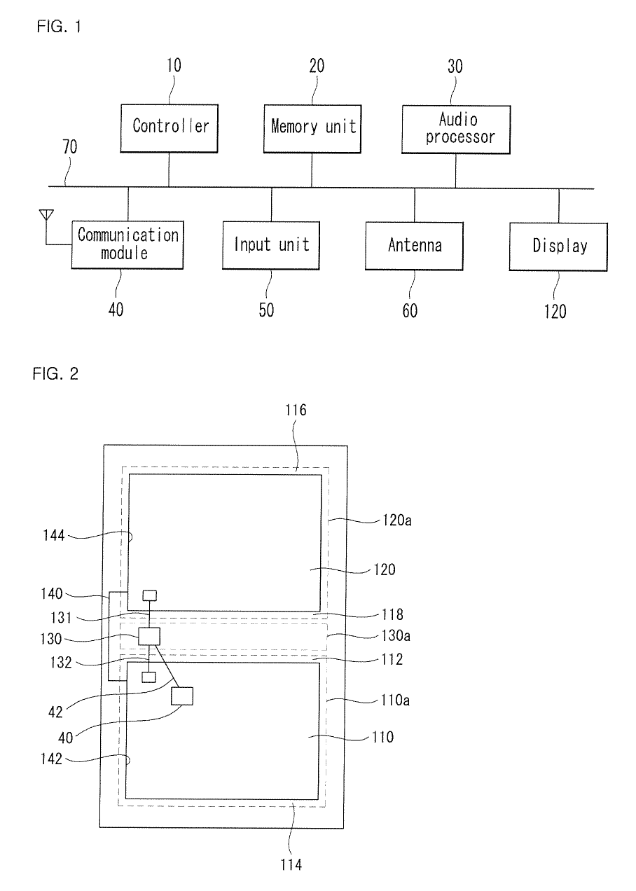

FIG. 1 is a block diagram illustrating a configuration of a mobile terminal. As best seen in FIG. 6, the various elements are housed in a housing or casing 80.

Referring to FIG. 1, the mobile terminal includes a controller 10, a memory unit 20, an audio processor 30, a communication module 40, an input unit 50, an antenna 60, and a display 120. The elements are connected by a bus 70.

The controller 10 controls the other elements and controls the general operations of the mobile terminal.

The memory unit 20 stores a predetermined program controlling the general operations of the mobile terminal and stores input or output data and various processed data when the general operations of the mobile terminal are performed by the controller 10.

The audio processor 30 processes audio to input and output the audio through a microphone and a speaker. The audio processor 30 processes audio to input various information or instructions as audio through the microphone and outputs various processing and control operations of the mobile terminal as audio through the speaker.

The communication module 40 is a wireless communication device for transmitting data to and receiving data from a mobile communication network.

The input unit 50 receives various information or instructions from a user and, by manipulation, receives various information or instructions from the outside. The input unit 50 may be a key button or a touch pad.

The antenna 60 transmits data through a mobile communication network processed by the communication module 40 or receives data through the mobile communication network, thereby enabling the communication module 40 to process the received data. The antenna 60 is a dipole antenna having a first conductive surface and a second conductive surface to be described later.

The controller 10 outputs a control signal to the display 120 for displaying a state of the mobile terminal or various information of the mobile terminal.

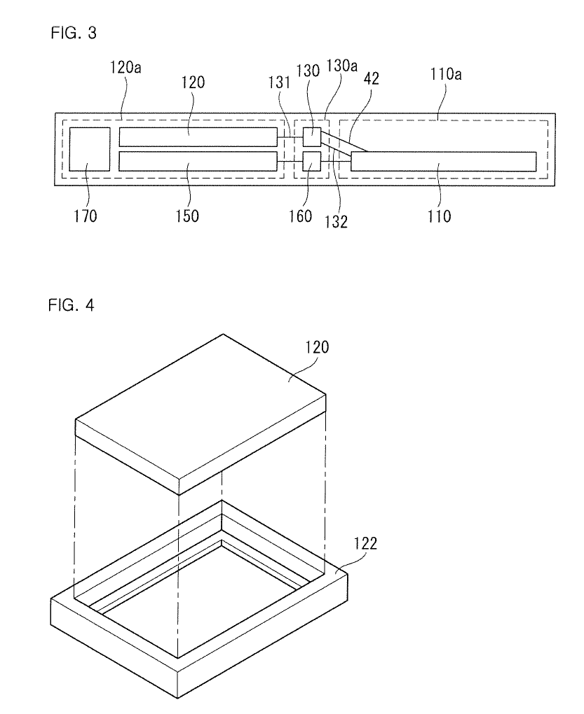

FIG. 2 is a plan view of an embodiment of a mobile terminal in which a signal connection line does not pass through a separation area. FIG. 3 is a side view of the mobile terminal of FIG. 2.

Referring to FIGS. 2 and 3, the mobile terminal includes a first printed circuit board 110. Various circuits of the mobile terminal are mounted on the first printed circuit board 110.

The first printed circuit board 110 is disposed on at least a portion of a first area 110a of the mobile terminal. The first area 110a may include a first upper area 112 and a first lower area 114, where upper and lower refer to the orientation of the mobile terminal when in use, in addition to the area where the first printed circuit board 110 is located.

The mobile terminal has a first conductive surface. The first conductive surface is disposed in the first area 110a and includes at least one of a plane surface or a curved surface made of or coated with a conductive material.

A ground is generally formed in the first printed circuit board 110, and the first conductive surface can be a ground of the first printed circuit board 110. In an alternative embodiment, a metal plate made of a thin metallic material can be placed next to a portion of the first printed circuit board 110, and the first conductive surface can be the metal plate. In another alternative embodiment, a conductive paint can be coated on a portion of the case that serves as a housing for the first area 110a, and the first conductive surface can be formed by the conductive paint.

The first conductive surface can be formed in various forms and is not limited to the above embodiments. That is, in some embodiments, at least one of conductive surfaces formed in the first area 110a is used as the first conductive surface.

Referring to FIGS. 2 and 3, the mobile terminal includes the communication module 40. The communication module 40 is disposed on the first printed circuit board 110. The communication module 40 is a communication-related device for transmitting data to and receiving data from the mobile communication network.

Referring to FIGS. 2 and 3, the mobile terminal includes the display 120. The display 120 may use a liquid crystal display (LCD). The display 120 is disposed in at least a portion of a second area 120a of the mobile terminal. The second area 120a is an area separated from the first area 110a and may comprise a second upper area 116 and a second lower area 118 in addition to the portion of the second area 120a where the display 120 is disposed.

The mobile terminal includes a second conductive surface. The second conductive surface is disposed in the second area 120a and comprises at least one of a plane surface or a curved surface made of or coated with a conductive material.

FIGS. 4 to 6 illustrate alternative embodiments of the second conductive surface.

Referring to FIG. 4, the mobile terminal may have a bracket 122 for securing and locating the display 120 in the mobile terminal. By forming the bracket 122 of a metallic material, the bracket 122 can be used as the second conductive surface. The bracket 122 has various forms and is not limited to the form shown in FIG. 4.

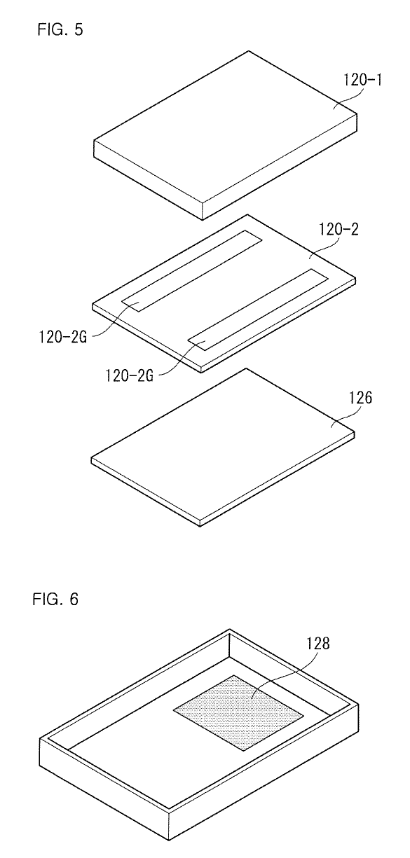

Referring to FIG. 5, the display 120 includes a display panel 120-1 (the separate elements of the display panel not shown) for displaying various images in the display 120, and a second printed circuit board 120-2 for mounting the separate elements of the display panel 120-1. On the second printed circuit board 120-2, the separate elements of the display panel are mounted, a signal line for connecting the elements using a signal is formed in a pattern, and a ground 120-2G is generally formed.

A ground 120-2G formed in the second PCB 120-2 may be the second conductive surface. The ground 120-2G formed in the second PCB 120-2 can have various forms and is not limited to the form shown in FIG. 5.

A metal plate 126 made of a thin metallic material may be attached to the lower surface of the second PCB 120-2. In this embodiment, the metal plate 126 may be the second conductive surface.

Referring to FIG. 6, a conductive paint 128 may be coated on a portion of the case that serves as a housing for the second area 120a. In this embodiment, the conductive paint 128 may form the second conductive surface.

The second conductive surface may have various forms and is not limited to the above-described embodiments. That is, in some embodiments, at least one conductive surface formed in the second area 120a is used as the second conductive surface.

Referring to FIGS. 2 and 3, the mobile terminal includes a feeding point 130. The feeding point 130 transmits a signal or a current applied to the communication module 40 to each of the first conductive surface and the second conductive surface or transmits a signal received by the first conductive surface or the second conductive surface to the communication module 40.

The feeding point 130 is formed in a separation area 130a. The feeding point 130 is formed between the upper end of the first upper area 112 and the lower end of the second lower area 118 and extends from the upper end of the first upper area 112 to the lower end of the second lower area 118.

The mobile terminal includes a first connection line 42 which is a signal line for the feeding point 130 to the communication module 40. The connection line 42 may be a coaxial cable.

Referring to FIGS. 2 and 3, the mobile terminal includes a second connection line 131 and a third connection line 132. The second connection line 131 is a signal line for connecting the feeding point 130 to the first conductive surface, and the third connection line 132 is a signal line for connecting the feeding point 130 to the second conductive surface.

The second connection line 131 and third connection line 132 are both connected to first connection line 42, which in turn is connected to the feeding point 130. In those embodiments where the connection line 42 is a coaxial cable the third connection line 132 is connected to an outer conductor of the coaxial cable.

Referring to FIG. 2, the mobile terminal includes a signal connection line 140 that is a signal line for connecting the first printed circuit board 110 to the display 120. For clarity, the signal connection line 140 is not shown in FIG. 3.

The signal connection line 140 is a signal line for operating the display 120 according to an input signal from the input unit 50 under control of the controller 10. The signal connection line 140 may be a flexible printed circuit board.

Referring to FIG. 2, it is preferable that a metal component should not be located in the separation area 130a, so that the signal connection line 140 should not pass through the separation area 130a. Therefore, the signal connection line 140 is formed on a path that passes through a side surface 142 of the display 120 from a side surface 144 of the first printed circuit board 110 in order not to pass through the separation area 130a.

Referring to FIG. 3, the mobile terminal includes a battery 150 for supplying power to the mobile terminal. In some embodiments, the battery 150 is disposed in a lower part of a rear surface of the display 120. In such embodiments, a power connection point 160 for connecting power from the battery 150 to the first printed circuit board 110 is formed in the separation area 130a. And in such embodiments, it is preferable that an inductor “L₂” (not shown) and a capacitor “C₂” (not shown) are connected to the power connection point 160.

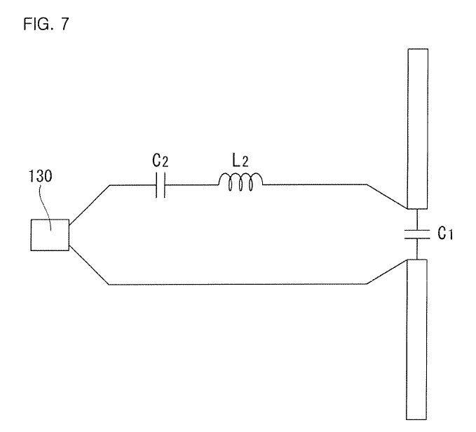

FIG. 7 is an equivalent circuit diagram of an embodiment of a mobile terminal in which the signal connection line 140 does not pass through the separation area 130a in which a power connection point 160 is formed and in which the inductor (not shown) and the capacitor (not shown) are connected to the power connection point 160.

Referring to FIG. 7, “C₁” is the capacitance value of a dielectric substance, such as air or a construction in addition to a metal component, located between the first conductive surface and the second conductive surface. Still referring to FIG. 7, “C₂” is the capacitance value of the capacitor connected to the power connection point 160 and “L₂” is the inductance value of the inductor connected to the power connection point 160. As shown in FIG. 7, the inductance value L₂ of the inductor connected to the power connection point 160 together with the capacitance values C₁ and C₂ are chosen to create a circuit and thereby cause matching at a specific frequency.

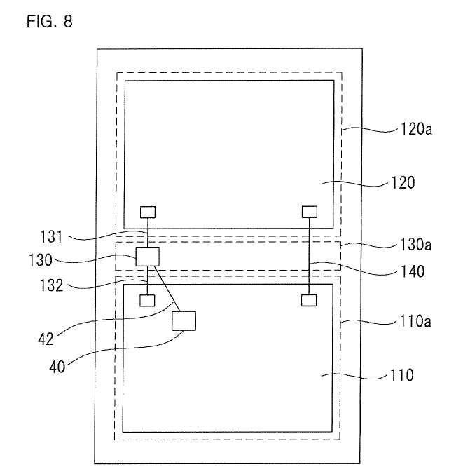

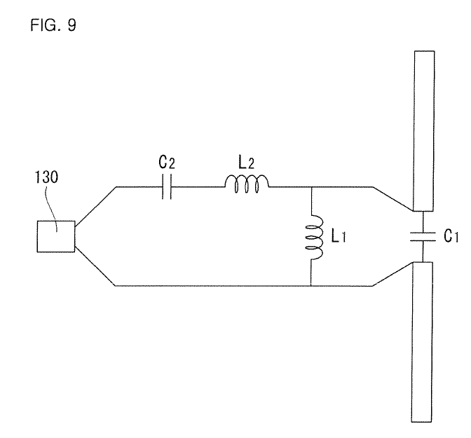

FIG. 8 is a plan view of an alternative embodiment of a mobile terminal in which the signal connection line 140 passes through the separation area 130a. FIG. 9 is the equivalent circuit diagram of the mobile terminal shown in FIG. 8 in which the power connection point 160 is formed in the separation area 130a, and in which an inductor (not shown) and a capacitor (not shown) are connected to the power connection point 160.

Referring to FIG. 9, “C₁” indicates the capacitance value of a dielectric substance, such as air or a construction in addition to a metal component located between the first conductive surface and the second conductive surface. And referring to FIG. 9, “L₁” indicates the inductance value of the signal connection line 140, “C₂” indicates the capacitance value of the capacitor connected to the power connection point 160, and “L₂” indicates the inductance value of an inductor (not shown) connected to the power connection point 160.

The inductance value L₂ of the inductor connected to the power connection point 160 together with L₁, C₁, and C₂, are selected to create a circuit and thereby cause matching at a specific frequency.

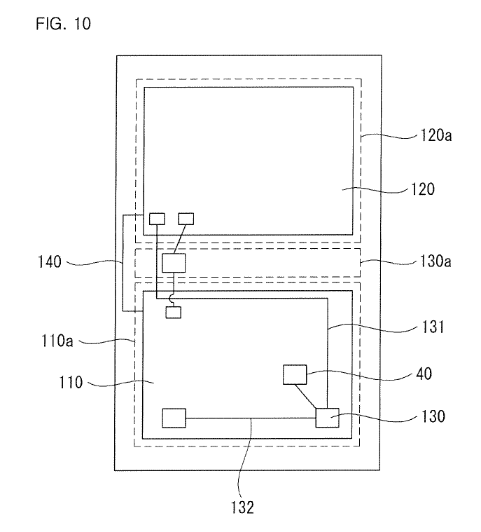

Referring to the embodiment of the mobile terminal shown in FIG. 10, the feeding point 130 is formed in the first printed circuit board 110. Although not shown, the battery 150 may be formed in the first area 130a.

In the embodiment shown in FIG. 10, the power connection point 160 is not formed in the separation area 130a and there are no values corresponding to “C₂” or “L₂”. Therefore, in an equivalent circuit analogous to FIGS. 7 and 9, the values for the first conductive surface, the second conductive surface, and the value C₁ are chosen at a specific frequency to cause matching.

Referring to FIG. 3, the mobile terminal includes a camera 170. A signal connection line (not shown) for connecting the camera 170 and the first printed circuit board 110 may pass through the first area 110a. In this embodiment, if an inductance value of the signal connection line (not shown) is L3, a value comprising L3 can be set to be matched at a specific frequency. The signal connection line can be formed on the flexible printed circuit board.

The mobile terminal may be a bar-type mobile terminal. In such embodiments, a swivel hinge is formed in the separation area 130a, such that the portion of the mobile terminal in which the second area 120a is formed can rotate relative to the portion of the mobile terminal in which the first area 110a is formed using the length of the mobile terminal as the axis direction.

The mobile terminal in accordance with the invention overcomes various drawbacks of conventional mobile terminals. For example, because a sufficient height is required to secure a predetermined bandwidth of the corresponding band, it is a drawback of conventional mobile terminals that they are generally required to have a space with an area of 2 to 4 cc to secure the performance of an internal antenna. As a result, mobile terminals may not have decreased size and thickness when an antenna is mounted within the mobile terminal.

It is a further drawback of conventional mobile terminals that cost increases when a separate internal antenna is mounted in the mobile terminal.

It is a still further drawback of conventional mobile terminals, that the antenna's performance is greatly influenced by a human body. A human body can cause the TRP and the TIS of an internal antenna to decrease by 7 dB or more.

It is an advantage of the present invention that the space for mounting an antenna is minimized by forming a dipole antenna from a conductive surface.

It is a further advantage of the present invention that increased performance is obtained when compared with existing antennas by forming a dipole antenna from a conductive surface.

It is further advantage of the present invention that the first conductive surface and the second conductive surface can be divided and formed in separate areas and that the first conductive surface and the second conductive surface can be formed to have similar lengths and widths, thereby improving an antenna performance.

It is a still further advantage of the present invention that the bandwidth is widened by widening the width of the first conductive surface and the second conductive surface, or the voltage standing wave ratio (VSWR) can be improved by narrowing the width of the first conductive surface and the second conductive surface.

It is a still further advantage of the present invention that a separate antenna is not required by using the ground of a printed circuit board disposed in the mobile terminal, a bracket of the display, or a conductive paint coating, as an antenna. Therefore, a separate space for mounting the antenna is not required. Moreover, the cost to manufacture a separate antenna is eliminated.

It is a further advantage of the present invention that the antenna's performance is less affected by a human body by using a wide conductive surface as an antenna.

It is a still further advantage of the present invention that deterioration of wireless performance by a hand effect decreases by forming a dipole antenna from a conductive surface.

Other features will be apparent from the description and drawings, and from the claims.

What is claimed is:

1. A mobile terminal having an internal antenna, the mobile terminal comprising:
a first area having a first conductive surface;
a second area having a second conductive surface, the second area separated from the first area; and
a feeding point formed between the first conductive surface and the second conductive surface to supply electrical signals to or from the first and the second conductive surfaces,
wherein the first and the second conductive surfaces together form the internal antenna.

2. The mobile terminal of claim 1, wherein the antenna is a dipole antenna.

3. The mobile terminal of claim 2, wherein both the first and second conductive surfaces are planar surfaces.

4. The mobile terminal of claim 2 wherein both the first and second conductive surfaces are curved surfaces.

5. The mobile terminal of claim 1, further comprising a communication module, wherein the feeding point is connected to the communication module to supply electrical signals from the communication module to the first and the second conductive surface and to supply electrical signals from the first and the second conductive surface to the communication module.

6. The mobile terminal of claim 5, wherein the feeding point is connected to the communication module with a coaxial cable.

7. The mobile terminal of claim 1 further comprising a separation area physically separating the first area and the second area and the feeding point disposed in the separation area.

8. The mobile terminal of claim 7, wherein the feeding point is formed between an upper end of the first area and a lower end of the second area in the separation area.

9. The mobile terminal of claim 7, further comprising a first printed circuit board disposed in the first area and a display disposed in the second area.

10. The mobile terminal of claim 9, further comprising a signal connection line electrically connecting the first printed circuit board to the display.

11. The mobile terminal of claim 10, wherein the signal connection line does not pass through the separation area.

12. The mobile terminal of claim 11, wherein the printed circuit board has a side surface the display has a side surface, and the signal connection line is formed in a path passing through the side surface of the display from the side surface of the first printed circuit board.

13. The mobile terminal of claim 11, further comprising:
a dielectric substance disposed between the first and second conductive surfaces;
a battery for supplying power to the mobile terminal;
a power separation point formed in the separation area;
an inductor connected to the power connection point; and
a capacitor connected to the power connection point, wherein the capacitance value of the dielectric substance, the capacitance value of the capacitor, and the inductance value of the inductor are selected to cause matching at a specific frequency.

14. The mobile terminal of claim 10, wherein the signal connection line passes through the separation area.

15. The mobile terminal of claim 14, further comprising:
a dielectric substance disposed between the first and second conductive surfaces;
a battery for supplying power to the mobile terminal;
a power separation point formed in the separation area;
an inductor connected to the power connection point; and
a capacitor connected to the power connection point, wherein the capacitance value of the dielectric substance, the capacitance value of the capacitor, the inductance value of the inductor and the inductance value of the signal connection line are selected to cause matching at a specific frequency.

16. The mobile terminal of claim 7, wherein the feeding point is formed in the first area and further comprising:
a dielectric substance disposed between the first and second conductive surfaces;
a battery for supplying power to the mobile terminal; and
a power separation point formed in the separation area, wherein the capacitance values of the first conductive surface, the second conductive surface and the dielectric substance are selected to cause matching at a specific frequency.

17. The mobile terminal of claim 7, wherein the first conductive surface is one of a ground of the first printed circuit board or a metal plate attached to the first printed circuit board.

18. The mobile terminal of claim 7, further comprising a housing for the first area, wherein the first conductive surface is formed by a conductive paint coated on a portion of the housing.

19. The mobile terminal of claim 7, wherein the second conductive surface is one of a bracket for the display, a ground of a second printed circuit board disposed in the display, a metal plate attached to the second printed circuit board, or a layer of conductive paint formed on the surface of the second area.

20. The mobile terminal of claim 1, wherein the mobile terminal is a bar-type mobile terminal.
